(19) United States
(12) Patent Application Publication
(10) Pub. No.: US 2026/0329517 A1
(43) Pub. Date: Oct. 22, 2026

(54) SYSTEM AND METHOD OF AUTOMATICALLY DISPLAYING A MOBILE SMART DEVICE WIRELESS VIDEO FEED IN A DISPLAY DEVICE SCREEN PARTITION LOCATED NEAREST TO THE MOBILE SMART DEVICE

(71) Applicant: Dell Products LP, Round Rock, TX (US)

(72) Inventors: Lei Guo, Singapore (SG); Siew Fei Lee, Singapore (SG); Yao-Te Peng, Singapore (SG)

(73) Assignee: Dell Products LP, Round Rock, TX (US)

(21) Appl. No.: 19/186,096

(22) Filed: Apr. 22, 2025

(51) Int. Cl. G06F 3/14; H04W 76/10

(52) U.S. Cl. CPC G06F 3/1454; H04W 76/10

(57) ABSTRACT

A digital display device executing a wireless video device position and display coordination system comprising a first antenna on a first side and a second antenna on a second side for establishing wireless connections with a mobile smart device, a wireless interface adapter to route a received mobile smart device video data input to a digital display hardware controller and to routinely measure relative signal strength indicators (RSSIs) of each of the wireless connections at the first antenna and the second antenna. The display device hardware controller to execute machine readable code instructions to determine a position of the mobile smart device that is closer to the first side of the display device than to the second side based on an comparison of the wireless RSSIs, and to display the mobile smart device video data input within a first partition of the display panel located closest to the determined position.

### FIELD OF THE DISCLOSURE

The present disclosure generally relates to digital display devices that operatively couple with an information handling system and a mobile smart device to perform as monitors or external displays for the information handling system and the mobile smart device. The present disclosure more specifically relates to a standalone digital display device executing machine readable code instructions of a wireless video device position and display coordination system and a picture by picture (PBP) video data inputs composer to automatically detect a position of a mobile smart device with respect to the digital display device and display video data input received from that device on a portion of the digital display device located nearest its identified position to provide a more intuitive user experience.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be operatively or wirelessly coupled to a digital display device for input or output of images or sound of digital media for a user.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating a digital display device executing machine readable code instructions of a wireless video device position and display coordination system and a picture by picture (PBP) video data inputs composer to automatically display video data input received from the mobile smart device on a portion of the digital display device located nearest to an identified position of the mobile smart device according to an embodiment of the present disclosure;

FIG. 2 is a graphical diagram illustrating display at a digital display device of video data input received from a mobile smart device and from an information handling system within a partitioned display panel with the video data input from the mobile smart device located closest to a determined initial position of the mobile smart device according to an embodiment of the present disclosure;

FIG. 3 is a graphical diagram illustrating a digital display device determining an updated position of a mobile smart device with respect to the digital display device according to an embodiment of the present disclosure;

FIG. 4 is a graphical diagram illustrating the digital display device partitioned to display the video data input received from a mobile smart device and from an information handling system within the digital display device display panel with the video data input from the mobile smart device switched to an updated position nearest to the new mobile smart device position according to an embodiment of the present disclosure; and

FIG. 5 is a flow diagram illustrating a method of orchestrating display of video data input received from a mobile smart device and an information handling system within a partitioned display panel based on a determined initial or updated position of the mobile smart device according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Digital display devices may operatively couple to information handling systems and to mobile smart devices such as smart phones to act as monitors or external displays for the information handling systems and mobile smart devices to display digital content. That digital content may be displayed simultaneously from the information handling systems and to mobile smart device in some embodiments. When operatively coupled, the digital display device may receive a video signal from such an operatively coupled information handling system or mobile smart device either wirelessly via a wireless interface adapter, or through a wired communication port such as a universal serial bus type-C (USB-C) port, USB 3.0 port, high definition multimedia interface (HDMI) port, DisplayPort ® (DP), or mini-DP ®, for example. A video signal received from each of the information handling system and the mobile smart device may be displayed in different partitioned segments of the digital display device screen or display panel, such as in a picture by picture (PBP) mode, in embodiments herein.

The partition or portion of the display screen of the standalone digital display device in which the video data input received from the mobile smart device may be displayed may be static or locked, such as always displaying mobile smart device video data on the left hand side of the display panel or always displaying it on the right hand side of the display panel while the other side serves as a default side for video data from an operatively coupled information handling system. However, this locked position may not correlate to the actual position of the mobile smart device with respect to the digital display device. For example, the digital display device may by default display the video feed received from a mobile smart device on the left side of the display panel, even when the mobile smart device is situated to the right of the digital display device. This may be confusing or non-intuitive for a user who has intentionally placed the mobile smart device to the right of the digital display device. A solution is needed that automatically adjusts the partition of the display panel in which the video feed from a mobile smart device is displayed to reflect the actual position of the mobile smart device with respect to the digital display device based on detected movement of the mobile smart device relative to the digital display device.

A digital display device executing machine readable code instructions of a wireless video device position and display coordination system and a picture by picture (PBP) video data inputs composer in embodiments of the present disclosure may address these issues by automatically detecting a position of a mobile smart device with respect to the digital display device and displaying video data input received from that mobile smart device on a portion of the digital display device located nearest its identified position. The other portion of the partitioned display screen may be used as a default to display video data input from the anchor information handling system in embodiments herein. This may provide a more intuitive user experience in that the user may expect to see the video data input from the mobile smart device near to its physical location. Further, when the user moves the mobile smart device to a new location, such as on the other side of the digital display device opposite to where it was previously located, the digital display device of in embodiments of the present disclosure may automatically detect the updated position and adjust the partitioned display of video data input received from that mobile smart device to appear within a side of the partitioned display screen of the digital display device located nearest to this updated position.

A mobile smart device may be operably connected to the digital display device wirelessly through one or more of primary wireless links with a first antenna or a second antenna of a wireless interface device of the digital display device. Such a first antenna or the second antenna may be situated on either side of the display panel or close to different vertical edges of the digital display device housing for the display panel in embodiments herein. In other embodiments, each side of the digital display device housing for the display panel may include a first plurality of antennas and as second plurality of antennas situated on opposite sides. A Radio Frequency (RF) front end of the wireless interface adapter for the digital display device may routinely measure signal strengths of the primary wireless link between each of the first antenna or first plurality of antennas and the second antenna or second plurality of antennas and the mobile smart device to determine whether the mobile smart device has a stronger wireless link with first antenna on a first side over a second antenna on a second side of the digital display device. A wireless video controller of the digital display device may execute machine readable code instructions of the wireless video device position and display coordination system to determine an initial position, such as left of center or right of center, of the mobile smart device with respect to a display panel of the digital display device. This determination may be based on a comparison of a radiofrequency signal strength, in dBm, for the mobile smart device and a first antenna on a first side and a radiofrequency signal strength for the mobile smart device and a second antenna on a second side of the digital display device. The mobile smart device should have a wireless link with a strongest signal strength (e.g., relative signal strength indicator (RSSI)) for the antenna, amongst oppositely-situated first and second antennas, that is situated closest to the mobile smart device. Thus, the display device hardware controller of the digital display device may execute machine readable code instructions of the wireless video device position and display coordination system to determine an initial position of the mobile smart device located closest to the antenna having a strongest signal strength based on a known position on one side or another with reference to the digital display device. This may include a position to the left or right of the digital display device, for example. The mobile smart device shares and establishes a wireless link for video data feed with the digital display device with at least one of the antennas.

A wired port of the digital display device may receive video data input data from a wired information handling system operatively coupled to the digital display device at a wired video controller having a coder-decoder (codec) to transform or pass along wired video data to a display device hardware controller such as a digital signal processing (DSP) and scaler hardware controller. A wireless interface device of the digital display device may receive a smart device wireless video data input from the mobile smart device and provide it to a wireless video controller having a codec to transform and pass along wireless video data to a display device hardware controller of the digital display device. A display device hardware controller of the digital display device may execute machine readable code instructions of the PBP video data inputs composer to orchestrate display of the smart device wireless video data input received from the mobile smart device within a partition of the display panel located closest to the determined initial position of the mobile smart device and wired video data from the operatively coupled information handling system. For example, the display device hardware controller of the digital display device may execute machine readable code instructions of the PBP video data inputs composer to orchestrate display of the smart device video data input received from the mobile smart device detected from signal strengths as located to the left of the digital display device within a partition on the left side of the display panel. The display device hardware controller of the digital display device may also execute machine readable code instructions of the PBP video data inputs composer to orchestrate display of the information handling system video data input received from the information handling system within an unassigned or default second partition of the display panel on the side opposite to that for the mobile smart device video data, such as within a right side of the display panel.

At routine intervals, the wireless video controller of the digital display device may receive signal strength measurements from a first antenna and a second antenna from the digital display device wireless interface adapter. The display device hardware controller or the wireless video controller in various embodiments may then execute machine readable code instructions of the wireless video device position and display coordination system to determine an updated position of the mobile smart device with respect to the display panel. This determination may be made based on an updated comparison of updated signal strength for the wireless connection, including a wireless data link, between the mobile smart device and the first antenna and the second antenna on opposing sides of the digital display device. If the user moves the mobile smart device from one side of the digital display device to the other, or from the left side to the right side, for example, the display device hardware controller or the wireless video controller of the digital display device may execute machine readable code instructions of the wireless video device position and display coordination system to determine that the wireless signal strength at the antenna previously showing the highest signal strength no longer has the highest signal strength. In other words, the wireless connection with the second antenna located to the right side of the display panel may have a highest signal strength during such an updated comparison, rather than the wireless connection with the first antenna on the left side of the housing for the display panel that initially had a highest signal strength. This may be a consequence or indicator of the mobile smart device having moved from the left side of the display panel to the right side of the display panel, for example.

If the display device hardware controller or the wireless video controller executing the wireless video device position and display coordination system determines that the mobile smart device has moved from an initial position closest to a first antenna located at the left vertical edge of the housing of the display panel to an updated position located closest to a second antenna located closest to the right vertical edge of the housing of the display panel, or vice-versa, for example, this may warrant shifting of the smart device wireless video data input to a different partition for display on the display panel. In such a case, the display device hardware controller may execute machine readable code instructions of the PBP video data inputs composer to orchestrate display of the smart device wireless video data input within a partition of the display panel located closest to the determined updated position of the mobile smart device, such as the right side of the display panel. The display device hardware controller may also execute machine readable code instructions of the PBP video data inputs composer to shift display of the information handling system wired video data input from the right-sided partition to the left-sided partition for display in such a scenario. This may provide a more intuitive user experience, based on actual placement of the mobile smart device as it moves with respect to the digital display device.

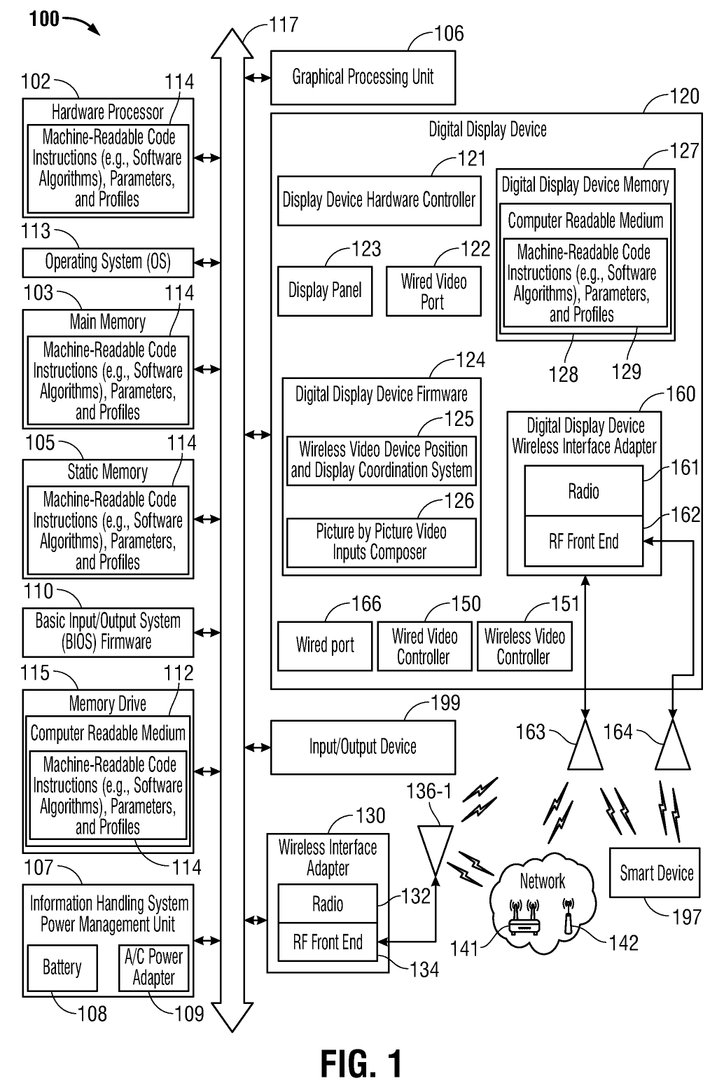

Turning now to the figures, FIG. 1 illustrates an information handling system 100 similar to the information handling systems according to several aspects of the present disclosure. As described herein, a digital display device 120 executing machine readable code instructions 129 of a wireless video device position and display coordination system 125 and a picture by picture (PBP) video data inputs composer 126 in an embodiment may automatically detect a position of a mobile smart device 197 with respect to the digital display device 120 and display wireless video data input received from that mobile smart device 197 on a portion of the digital display device 120 located nearest its identified position. This may provide a more intuitive user experience in that the user may expect to see the video data input from the mobile smart device 197 near to its physical location. Further, when the user moves the mobile smart device 197 to a new location, such as on the other side of the digital display device 120 than where it was previously located, the digital display device 120 in an embodiment may automatically detect the updated position and adjust the display of wireless video data input received from that mobile smart device 197 to appear within a portion of the partitioned digital display device 120 located nearest this updated position.

A mobile smart device 197 may be operably coupled to the digital display device 120 wirelessly through a plurality of wireless connections, one or more of which may form wireless links for data transfer, with a plurality of antennas including a first antenna 163 and a second antenna 164 of a wireless interface device 160 of the digital display device 120. Such a first antenna 163 and a second antenna 164 may be situated on either side (e.g., right side and left side) of a housing of the display panel 123 or close to different vertical edges of the housing for the digital display device 120 in an embodiment. A Radio Frequency (RF) front end 162 of the wireless interface adapter 160 for the digital display device 160 may routinely measure signal strengths of the wireless connections between each of the first antenna 163 and the second antenna 164 and the mobile smart device 197 to determine whether the mobile smart device 197 has a stronger wireless link with one antenna over another. More specifically, the RF front end 162 may routinely check a relative signal strength indicator (RSSI) for each wireless connection, whether active as a wireless link or not, with first antenna 163 and the mobile smart device 197 and the second antenna 164 and the mobile smart device 197. The wireless link between the mobile smart device 197 and the antenna, such as the first antenna 163 in an example, situated nearest the mobile smart device 197 should have a highest RSSI in comparison to the RSSI of the wireless connection between the mobile smart device 197 and the other antenna, such as second antenna 164, situated on the housing of the digital display device 120 farther from the mobile smart device 197.

A wireless video controller 151 of the digital display device 120 may execute machine readable code instructions 129 of the wireless video device position and display coordination system 125 to receive the RSSI data of the first antenna 163 and second antenna 164 from the display device wireless interface adapter 160. In an embodiment, wireless video controller 151 of the digital display device 120 may execute machine readable code instructions 129 of the wireless video device position and display coordination system 125 to determine a position, such as an initial position, of the mobile smart device 197 with respect to a display panel 123 of the digital display device 120 based on known location of the first antenna 163 and the second antenna 164. In other embodiments, the digital display hardware controller 121 of the digital display device 120 may execute some or all of the machine readable code instructions 129 of the wireless video device position and display coordination system 125 to determine the position of the mobile smart device 197 with respect to the digital display device 120. This determination may be based on a comparison of an initial signal strength or RSSI for the wireless connections between the mobile smart device 197 and the first antenna 163 and the second antenna 164 as detected at the radio 161 and RF front end 162 of the digital display device wireless adapter 160. The mobile smart device 197 should establish a wireless link with a strongest signal strength for an antenna, such as 163, that is situated closest to the mobile smart device 197.

Thus, the wireless video controller 151 or the digital display device hardware controller 121 of the digital display device 120 may execute some or all of the machine readable code instructions of the wireless video device position and display coordination system 125 to determine an initial position of the mobile smart device 197 located closest to an antenna, such as 163, having a known position with reference to the display panel 123 based on the stronger RSSI or other signal strength measurement. This position may include a position to the left or right of the center of the digital display device 120, for example. If the mobile device is centered such that the differences between the RSSI values of wireless connections to the first antenna 163 and second antenna 164 are not beyond a threshold amount, such as a threshold difference of 3 dBm, the last arrangement of a partitioned display panel 123 may remain in place for display of video data input from both the mobile smart device 197 and the information handling system 100 in embodiments herein. Other threshold difference amounts are contemplated in various embodiments and this threshold difference amount prevents side switching of the partitioned display panel 123 from being too sensitive when the mobile smart device 197 is placed roughly center before the digital display device 120.

More specifically, the wireless video controller 151 or the display device hardware controller 121 of the digital display device 120 may execute machine readable code instructions of the wireless video device position and display coordination system 125 to determine if the RSSI for the wireless connection with antenna 163 differs from the RSSI for the wireless connection with antenna 164 by more than an initial threshold difference value and for an initial threshold time period. For example, the wireless video controller 151 of the digital display device 120 may determine whether the RSSI for the wireless connection with antenna 163 differs from the RSSI for the wireless connection with antenna 164 by a value of at least three decibels relative to milliwatts (dBm) for a period of at least one second. The wireless video controller 151 of the digital display device 120 may execute machine readable code instructions of the wireless video device position and display coordination system 125 to determine an initial position of the mobile smart device 197 located closest to an antenna 163 situated to the left side of the display panel 123, with which the mobile smart device 197 shares a wireless connection, which may be formed into a wireless link for wireless data communication, having an RSSI of at least 3 dBm greater than the RSSI of the wireless connection between antenna 164 and the mobile smart device 197 for over a period of at least one second.

A wired video controller 150 or the wireless video controller 151 of the digital display device 120 may receive a wired or wireless information handling system video data input from display device wired ports 166 or the wireless interface adapter 160, respectively, from the information handling system 100. This wired or wireless information handling system video data input may be received on a secondary video data input relative to the mobile smart device wireless video data input received via a wireless link that is a primary video data input in an embodiment. The wireless video controller 151 of the digital display device 120 may receive a smart device video data input from the mobile smart device 197, via the wireless interface device 160 of the digital display device 120, on a wireless link with the mobile smart device 197. The primary video data input and the secondary video data input are relative to one another with respect to execution of the machine readable code instructions of the wireless video device position and display coordination system 125 to select which video data input to move within a partitioned display on the display panel 123. In some embodiments described herein, the information handling system video data input is received via a wired port 166, but other embodiments herein contemplate that information handling system video data input may be received on a secondary wireless link via the display device wireless interface adapter 160.

A display device hardware controller 121 of the digital display device 120 may execute machine readable code instructions 129 of the PBP video data inputs composer 126 to orchestrate display of the smart device video data input received from the mobile smart device 197 within a partition of the display panel 123 located closest to the determined initial position of the mobile smart device 197 (e.g., to the left of the digital display device 120) along with display of the information handling system video data input in the other partition. For example, the display device hardware controller 121 of the digital display device 120 may execute machine readable code instructions 129 of the PBP video data inputs composer 126 to orchestrate display of the smart device video data input received from the mobile smart device 197 located to the left of the digital display device 120 within a partition on the left side of the display panel 123. The display device hardware controller 121 of the digital display device 120 may also execute machine readable code instructions 129 of the PBP video data inputs composer 126 to orchestrate display of the information handling system video data input received from the information handling system 100 via a wired port 166 or secondary wireless link within an unassigned, second partition of the display panel 123, such as within a right side of the display panel 123.

At routine intervals, the wireless video controller 151 of the digital display device 120 may execute machine readable code instructions 129 of the wireless video device position and display coordination system 125 to retrieve updated RSSI or signal strength readings for first antenna 163 and second antenna 164 from the display device wireless interface adapter 160. The wireless video controller 151 and the display device hardware controller 121 execute some or all machine readable code instructions 129 of the wireless video device position and display coordination system 125 to determine an updated position of the mobile smart device 197 with respect to the display panel 123. This determination may be made based on an updated comparison of updated signal strength for the wireless connections between the mobile smart device 197 and the first antenna 163 and between the mobile smart device 197 and the second antenna 164 of the digital display device 120. If the user moves the mobile smart device 197 from one side of the digital display device 120 to the other, for example from the left side to the right side, the wireless video controller 151 or the display device hardware controller 121 may execute machine readable code instructions of the wireless video device position and display coordination system 125 to determine that the antenna, such as first antenna 163, previously showing the highest signal strength no longer has the highest signal strength. In other words, the wireless connection with the second antenna 164 located to the right side of the display panel 123 may now have a higher signal strength above a difference threshold level than the wireless link with the first antenna 163 on the left side during such an updated comparison.

More specifically, the wireless video controller 151 or the display device hardware controller 121 may execute machine readable code instructions of the wireless video device position and display coordination system 125 to determine if the updated RSSI for the wireless link with antenna 163 differs from the updated RSSI for the wireless link with antenna 164 by more than an updated signal strength threshold difference value and for an updated position threshold time period. For example, the wireless video controller 151 or the display device hardware controller 121 may determine whether the updated RSSI for the wireless connection with antenna 163 differs from the updated RSSI for the wireless connection with antenna 164 by a value of at least five decibels relative to milliwatts (dBm) for a period of at least five seconds. Other signal strength threshold difference values and position time threshold values are contemplated in embodiments herein and may affect sensitivity of the system. In some embodiments, the updated signal strength threshold difference value of five dBm may be greater than the initial signal strength threshold difference value of three dBm or the updated position threshold time period of five seconds may be greater than the initial threshold time period of one second in some embodiments. This may be the case because the initial determination of the mobile smart device 197 location must be performed prior to the display of any smart device video feed received from the mobile smart device 197 via the digital display device 120. In order to minimize any lag or delay in the display of such a smart device video data feed, the determination of the initial position may be made quickly, such as within one second and may benefit from a more sensitive threshold signal strength difference in some embodiments. The wireless video controller 151 or the display device hardware controller 121 of the digital display device 120 may execute machine readable code instructions of the wireless video device position and display coordination system 125 to determine an updated position of the mobile smart device 197 located closest to the second antenna 164 situated to the right side of the display panel 123 based on the signal strength difference between antennas 164 and 163 exceeding a signal strength threshold difference value for a position threshold time period. This may be a consequence or indicator of the mobile smart device 197 having moved from the left side of the display panel 123 to the right side of the display panel 123, for example.

If the wireless video controller 151 determines that the mobile smart device 197 has moved from an initial position closest to a first antenna 163 located closest to the left vertical edge of the display panel 123 to an updated position located closest to a second antenna 164 located closest to the right vertical edge of the display panel 123, or vice-versa, for example, this may warrant shifting of the smart device video data input to a different partition of the display panel 123. In such a case, the display device hardware controller 121 may execute machine readable code instructions 129 of the PBP video data inputs composer 126 to orchestrate display of the smart device wireless video data input within a partition of the display panel 123 located on a side of the display panel 123 closest to the determined updated position of the mobile smart device 197, such as the right side of the display panel 123. The display device hardware controller 121 may also execute machine readable code instructions 129 of the PBP video data inputs composer 126 to shift display of the information handling system video data input received via the wired ports 166 or a secondary wireless link from the right-sided partition to the left-sided partition in such a scenario. This may provide a more intuitive user experience, based on actual placement of the mobile smart device 197 as it moves with respect to the digital display device 120.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), a graphics processing unit (GPU) 106, other hardware controllers, or any combination thereof. Additional components of the information handling system 100 may include one or more storage devices such as static memory 105 or drive unit 115. The information handling system 100 may include or interface with one or more communications ports for communicating with external devices, as well as one or more input/output (IO) devices 199, a video/graphics digital display device 120, or any combination thereof. Digital display device 120 may include an external, standalone digital display device operatively coupled to the information handling system 100 in embodiments herein. Portions of an information handling system 100 may themselves be considered information handling systems 100.

The digital display device 120 may also include digital display device memory 127, (volatile (e.g., random-access memory, etc.), or static, nonvolatile (read-only memory, flash memory etc.) or any combination thereof). Digital display device 120 may include memory 127, which may be volatile or nonvolatile memory (read-only memory, flash memory etc.) or any combination thereof storing machine readable code instructions (e.g., software or firmware algorithms), parameters, and profiles 129 executable by the display device hardware controller 121, wired video controller 150, or wireless video controller 151. One or more hardware processing resources may also be included within digital display device 120, such as a display device hardware controller 121 that may be a DSP or scalar hardware processor, microcontroller, other hardware controllers, such as wired video controller 150, wireless video controller 151, or any combination thereof. In other embodiments, the display device hardware controller 121 may comprise a scalar central processing unit (CPU), or timing controller (TCON).

Information handling system 100 may include devices or modules that embody one or more of the hardware devices or hardware processing resources executing machine readable code instructions for one or more systems and modules. The information handling system 100 may execute machine readable code instructions (e.g., software or firmware algorithms), parameters, and profiles 114 that may operate on servers or systems, remote data centers, or on-box in individual client information handling systems according to various embodiments herein. The digital display device 120 may execute machine readable code instructions (e.g., software or firmware algorithms), parameters, and profiles 129 that may operate according to various embodiments herein. In some embodiments, it is understood any or all portions of machine readable code instructions (e.g., software or firmware algorithms), parameters, and profiles 114 or 129 may operate on a plurality of information handling systems 100 and on digital display device 120.

The information handling system 100 may include the hardware processor 102 such as a central processing unit (CPU) or other hardware processing resources on information handling system 100 or a display device hardware controller 121, such as DSP or scaler hardware controller, timing controller (TCON), or other hardware controller on the digital display device 120. Any of the hardware processing resources may operate to execute machine readable code instructions 114 or 129 that are either firmware or software code. The display device hardware controller 121 may execute machine readable digital display device firmware 124, wireless video device position and display coordination system 125, or PBP video data inputs composer 126 according to embodiments herein. The digital display device 120 in some embodiments may include a separate display device hardware controller 121, such as the DSP and scaler hardware controller, to execute machine readable code instructions 129 of digital display device firmware 124, wireless video device position and display coordination system 125, or PBP video data inputs composer 126 in embodiments herein. In such an embodiment, the digital display device 120 includes the display device hardware controller 121 that may comprise a scalar CPU, a digital signal processing (DSP) controller, a TCON, or other on-board processor on the digital display device 120. In further embodiments herein, the digital display device 120 may include a wired video controller 150 for operative coupling to the wired ports 166 to receive wired video data input from the information handling system 100. The wired video controller 150 may execute a codec to receive wired video data input as well as operate with the wired port data protocol to receive and forward the wired video data input to the display device hardware controller 121 in embodiments herein. In another embodiment, the digital display device 120 may include a wireless video controller 151 for operative coupling to the digital display wireless interface adapter 160 to receive wireless video data input, such as from the smart mobile device 157, or from the information handling system 100 in some embodiments. The wireless video controller 151 may execute a codec to receive wireless video data input as well as operate with the wireless interface adapter 160 to receive and forward the wireless video data input to the display device hardware controller 121 in embodiments herein. The hardware processor 102 in the information handling system 100 may comprise a vector CPU or multi-vector CPU or may be a graphics processing unit (GPU) 106 or other hardware processing resource.

Moreover, the information handling system 100 may include memory such as main memory 103, static memory 105, and disk drive unit 115 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, GPU 106, or any other hardware processing device. The information handling system 100 may also include one or more buses 117 operable to transmit communications between the various hardware components such as any combination of various I/O devices 199, as well as between hardware processors 102, GPU 106 or other, the operating system (OS) 113, the basic input/output system (BIOS) 110, the wireless interface adapter 130, or a radio module 132, among other components described herein. In an embodiment, the hardware processor 102, and/or GPU 106 may execute one or more bus drivers in order to transmit this data between the information handling system 100 and the input/output devices 199 described herein.

According to embodiments described herein, the information handling system 100 further includes a video/graphics digital display device 120 or may be operably coupled to a standalone digital display device 120. The video/graphics digital display device 120 in embodiments herein may function as a liquid crystal display (LCD), an organic light emitting diode (OLED), a flat panel display, or a solid-state display. The digital display device 120 has a display screen panel 123 is described for display of digital media received via wired or wireless video data inputs. It is appreciated that the video/graphics digital display device 120 may be one or more external video/graphics digital display devices 120 according to embodiments herein that allow a user to increase the display-viewable desktop area by providing for or extending the desktop displayed for the information handling system 100 in an embodiment.

A network interface device 130 of the information handling system 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the network 140, via, for example, a Bluetooth® or Bluetooth® Low Energy (BLE) protocols, or other WPAN or WLAN protocols.

Further, a digital display device network interface device 160 of the digital display device 120 may be wireless and can provide wireless connectivity among devices such as with Bluetooth® or to a network 140, e.g., a WAN, WWAN, LAN, WLAN, PAN, or WPAN, or other network. In embodiments described herein, the digital display device network interface device 160 with its radio 161, RF front end 162 and antenna 163 is used to communicate with the network 140, or directly with a smart device 197, via, for example, a Bluetooth® or Bluetooth® Low Energy (BLE) protocols, or other WPAN or WLAN protocols. The wired ports 166 of the digital display device 120 may accommodate wired connections including universal serial bus (USB), DisplayPort (DP), high definition multimedia interface (HDMI) or other wired protocol ports in embodiments herein to receive wired video data input.

In an embodiment, a WAN, WWAN, LAN, and WLAN may each include an AP 141 or base station 142 used to operatively couple the information handling system 100 or the digital display device 120 to a network 140 via a wireless interface adapter 130, or a digital display device wireless interface adapter 160, respectively. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system 100 or the digital display device 120. Wireless interface adapter 130 or digital display wireless interface adapter 160 may include one or more radio frequency (RF) subsystems (e.g., radio 132, or radio 161, respectively) with transmitter/receiver circuitry, modem circuitry, one or more antenna RF front end circuits 134 or 162, respectively, one or more wireless controller circuits, amplifiers, antennas 136 or 163/164, respectively and other circuitry of the radio 132 or radio 161, respectively, such as one or more antenna ports used for wireless communications via multiple radio access technologies (RATs). The radio 132 or radio 161 may communicate with one or more wireless technology protocols.

In an embodiment, the wireless interface adapter 130 or digital display wireless interface adapter 160 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth ® protocols in some embodiments. Wireless interface adapter 130 or digital display wireless interface adapter 160 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 or digital display wireless interface adapter 160 can represent an add-in card, wireless network interface module that is integrated with a main board of the information handling system 100 or digital display device 120, respectively, or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium 112 that includes machine-readable code instructions, parameters, and profiles 114 and a computer-readable medium 128 that includes machine-readable code instructions, parameters, and profiles 129 or receives and executes instructions, parameters, and profiles 114 or 129 responsive to a propagated signal, so that a hardware device connected to a network 140 may communicate voice, video, or data over the network 140. Further, the machine readable code instructions 114 or 129 may be transmitted or received over the network 140 via the network interface device or wireless interface adapter 130 or digital display wireless interface adapter 160. The present disclosure also contemplates machine-readable code instructions, parameters, and profiles 129 executing on a display device hardware controller 121 on-board the digital display device 120 and includes machine readable code instructions, parameters, and profiles of digital display device firmware 124, wireless video device position and display coordination system 125, or PBP video data inputs composer 126 to execute system and methods of embodiments of the present disclosure.

The information handling system 100 may include a set of instructions 114, digital display device firmware 124, wireless video device position and display coordination system 125, or PBP video data inputs composer 126 that may be executed to cause the digital display device 120 to perform any one or more of the methods or computer-based functions disclosed herein. For example, machine readable code instructions 114 may be executed by a hardware processor 102, GPU 106, or any other hardware processing resource and may include software agents, or other aspects or components used to execute the methods and systems described herein. In another example, machine readable code instructions 129 may be executed by a digital device hardware controller 121 or other hardware processing resource on-board a digital display device 120 for execution of digital display device firmware 124, wireless video device position and display coordination system 125, or PBP video data inputs composer 126 according to parameters and instructions at the digital display device 120. Various software modules or firmware modules comprising application machine readable code instructions 114 may be coordinated by an OS 113, and/or via an application programming interface (API) include a unified device API described herein. An example OS 113 may include Windows ®, Android ®, and other OS types. Example APIs may include Win 32, Core Java API, or Android APIs.

In an embodiment, the information handling system 100 may include a disk drive unit 115. The disk drive unit 115 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 115 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 115 during execution by the hardware processor 102, or GPU 106 of information handling system 100.

The digital display device 120 may include digital display device memory 127, which may include machine-readable code instructions, parameters, and profiles 129 in which one or more sets of machine-readable code instructions, parameters, and profiles 129 such as firmware or software can be embedded to be executed by the hardware controller 121, or other microcontroller unit, including wired video controller 150 and wireless video controller 151 to perform the processes described herein. The digital display device memory 127 may also contain space for data storage. Further, the machine-readable code instructions, parameters, and profiles 129 may embody one or more of the methods as described herein. In a particular embodiment, the machine-readable code instructions, parameters, and profiles 129 may reside completely, or at least partially, within the digital display device memory 127 during execution by the hardware controller 121, wired video controller 150, or wireless video controller 151 of the digital display device 120.

Main memory 103, digital display device memory 127, or other memory of the embodiments described herein may contain computer-readable medium (not shown), such as RAM in an example embodiment. An example of main memory 103, or digital display device memory 127 includes random access memory (RAM) such as static RAM (SRAM), dynamic RAM (DRAM), non-volatile RAM (NV-RAM), or the like, read only memory (ROM), another type of memory, or a combination thereof. Static memory 105, or digital display device memory 127 may contain computer-readable medium (not shown), such as NOR or NAND flash memory in some example embodiments. The applications and associated APIs, for example, may be stored in static memory 105 or on the disk drive unit 115 that may include access to a machine-readable code instructions, parameters, and profiles 114 such as a magnetic disk or flash memory in an example embodiment. Digital display device firmware 124, wireless video device position and display coordination system 125, or PBP video data inputs composer 126, for example, may be stored in digital display device memory 127 in computer readable medium 128 that may include access to a machine-readable code instructions, parameters, and profiles 129 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 107 (a.k.a. a power supply unit (PSU)). The PMU 107 may include a hardware controller and executable machine-readable code instructions to manage the power provided to the components of the information handling system 100 such as the hardware processor 102 and other hardware components described herein. The PMU 107 may control power to one or more components including the one or more drive units 115, the hardware processor 102 (e.g., CPU), the GPU 106, a video/graphic digital display device 120, or other wired I/O devices 199 and other components that may require power when a power button has been actuated by a user. In an embodiment, the PMU 107 may monitor power levels and be electrically coupled to the information handling system 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 112 or 128 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

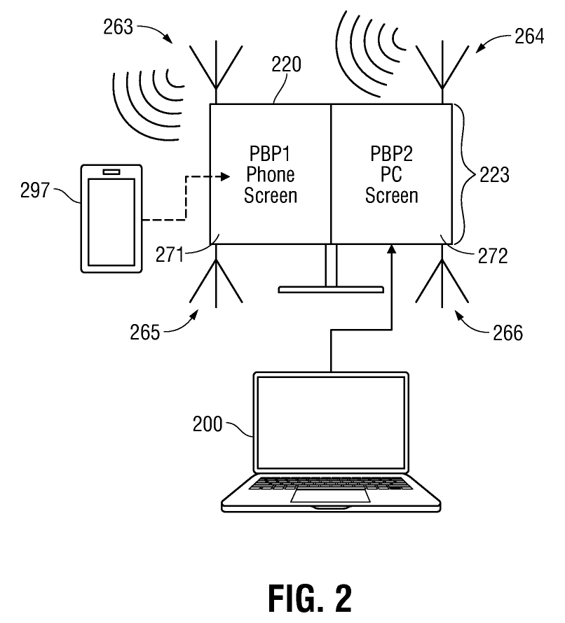

FIG. 2 is a graphical diagram illustrating a digital display device orchestrating display of video data input received from a mobile smart device within a partition of a display panel of a digital display device located closest to a determined initial position of the mobile smart device based on comparison of signal strengths for wireless links between the mobile smart device and a plurality of antennas of the digital display device according to an embodiment of the present disclosure. An information handling system 200 in an embodiment may be operably connected to a digital display device 220 through a wired video port or through a secondary wireless link with a wireless interface device of a digital display device 220. A mobile smart device 297 in an embodiment may be operably coupled to the digital display device 220 wirelessly through a plurality of primary wireless connections with a first antenna 263 and a second antenna 264 of the wireless interface device of the digital display device 220, either of which may be used to form a wireless link for wireless video data communications. A Radio Frequency (RF) front end of the wireless interface adapter for the digital display device 220 in an embodiment may routinely measure signal strengths of the wireless connections between mobile smart device 297 and each of the first antenna 263 and the second antenna 264 in embodiments herein.

In an embodiment, the information handling system 200 may be operably connected via a secondary wireless link with an alternative antenna between the first antenna 263 or second antenna 264 when operating in the same wireless protocol, such as Wi-Fi for example, or may be operably coupled via a secondary wireless link of a different wireless protocol, such as Bluetooth ® for example, with a different plurality of third antenna 265 or fourth antenna 266 of the digital display device 220. In other embodiments, the information handling system 200 may be operably connected to the digital display device 220 via a wired link and wired ports to deliver information handling system video data input. These wired ports may be treated as a secondary data link in some embodiments for assessment by the wireless video device position and display coordination system in embodiments herein. In some embodiments, the RF front end of the wireless interface adapter for the digital display device 220 may also routinely measure signal strengths for each of the information handling system wireless links between the third and fourth antennas 265 and 266 and the information handling system 200 as confirmation of determination of a side for the mobile smart device 297.

A wireless video controller or display device hardware controller of the digital display device 200 in an embodiment may execute some or all machine readable code instructions of a wireless video device position and display coordination system to determine an initial position of the mobile smart device 297 to a first side (e.g., left side) of the display panel 223 of the digital display device 220. This determination may be based on a comparison of an initial signal strength for the wireless connection between the mobile smart device 297 and the first antenna 263 (e.g., left antenna) and the signal strength for the wireless connection between the mobile smart device 297 and the second antenna 264 (e.g., the right antenna). If a wireless connection with a first antenna 263 has a stronger relative signal strength indicator (RSSI) than a wireless connection with the second antenna 264 by more than a signal strength threshold difference value, for example, it may be determined that the mobile smart device 297 is located closer to the first antenna 263 than to the second antenna 264 (e.g., on the left side). Because the wireless video device position and display coordination system associates the first antenna 263 with mounting the left side of the housing for the display panel 223 in an embodiment, the wireless video controller or display device hardware controller of the digital display device 220 in such an embodiment may execute machine readable code instructions of the wireless video device position and display coordination system to determine that the mobile smart device 297 is located closer to the side of the display panel 223 with the first antenna 263 (e.g., the left side) than to the side of the display panel 223 with the second antenna 264 (e.g., the right side). As described in greater detail herein, it may be appropriate in this circumstance to display the smart mobile device wireless video input data from the mobile smart device 297 in a left-side partition 271 of the display panel 223 located closest to the mobile smart device 297.

In an embodiment, the information handling system video data input, whether received via wired port or a secondary wireless link, may be then displayed in a right-side partition 272 of the display panel 223 (e.g., away from mobile smart device 297) by default. A display device hardware controller of the digital display device 220 in an embodiment in which it is determined that the mobile smart device 297 is located closest to the antenna 263 may execute machine readable code instructions of a picture by picture (PBP) video data inputs composer to orchestrate display of the smart device video data input received from the mobile smart device 297 within a partition 271 of the display panel 223 located closest to the determined initial position of the mobile smart device 297 to the left side of the display panel 223. Similarly, the display device hardware controller of the digital display device 220 in such an embodiment may execute machine readable code instructions of a picture by picture (PBP) video data inputs composer to orchestrate display of the information handling system video data input in a right-side partition 272 of the display panel 223 by default.

In some embodiments, where the information handling system 200 is operably coupled via wireless connections with third antenna 265 (e.g., on a left side) and fourth antenna 266 (e.g., on a right side) on the digital display device 220, the determination of location of the smart mobile device 297 may be further confirmed by a comparison of wireless connection signal strengths between the information handling system 200 and the third antenna 265 and the wireless connection signal strengths between the information handling system 200 and the fourth antenna 266. If a wireless connection signal strength between the information handling system 200 and the fourth antenna 266 has a stronger relative signal strength indicator (RSSI) than a wireless connection with the third antenna 265, for example, it may be determined that the information handling system 200 is located closer to the fourth antenna 266 (e.g., the right side) than to the third antenna 265 (e.g., the left side). Because the wireless video device position and display coordination system associates the fourth antenna 266 with the right side of the display panel 223 in an embodiment, the wireless video controller of the digital display device 200 in such an embodiment may execute machine readable code instructions of the wireless video device position and display coordination system to determine that the information handling system 200 is located closer to the right side of the display panel 223 than to the left side of the display panel 223. This may be used in some embodiments as a confirmation that it may be appropriate in this circumstance to display mobile smart device wireless video input data from the mobile smart device 297 in a left-side partition 271 of the display panel 223 and display the information handling system 200 screen on the right-side partition 272 of the display panel 223.

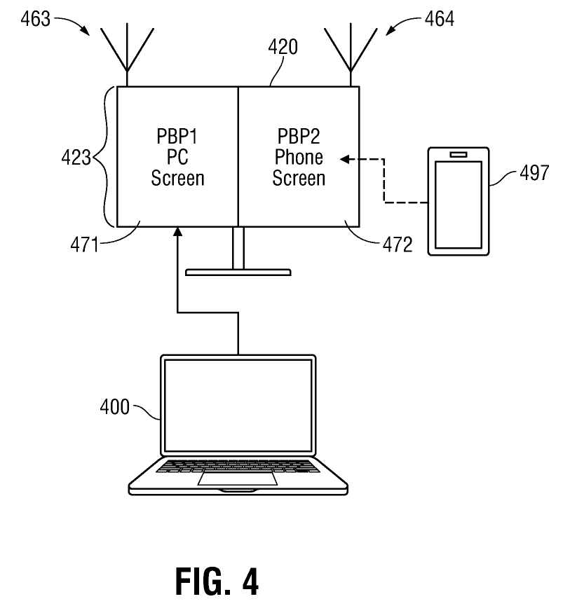

In another example embodiment, the wireless connection with second antenna 264 has a stronger RSSI than the wireless connection with the first antenna 263 by more than a threshold amount, it may be determined that the mobile smart device 297 is located closer to the second antenna 264 than to the first antenna 263. Because the wireless video device position and display coordination system associates the second antenna 264 with its mounting on the display housing on the right side of the display panel 223 in an embodiment, the wireless video controller or display device hardware controller of the digital display device 220 in such an embodiment may execute machine readable code instructions of the wireless video device position and display coordination system to determine that the mobile smart device 297 is located closer to the right side of the display panel 223 than to the left side of the display panel 223. As described in greater detail herein, it may be appropriate in this circumstance to display the mobile smart device wireless video data input from the mobile smart device 297 in the right-side partition 272 of the display panel 223 located closest to the mobile smart device 297 when located closest to second antenna 264 such as shown similar to the embodiment in FIG. 4.

The information handling system video input data, whether received via wired or wireless connection, may then be displayed in the left-side partition 271 of the display panel 223 away from the mobile smart device 297 as a default in this second location embodiment. A display device hardware controller of the digital display device 220 in which it is determined that the mobile smart device 297 is located closest to the second antenna 264 may execute machine readable code instructions of a picture by picture (PBP) video data inputs composer to orchestrate display of the smart device video data input received from the mobile smart device 297 within a right-side partition 272 of the display panel 223 located closest to the determined position of the mobile smart device 297 to the right side of the display panel 223 in this second location embodiment. Similarly, the display device hardware controller of the digital display device 220 in such an embodiment may execute machine readable code instructions of a picture by picture (PBP) video data inputs composer to orchestrate display of the information handling system video data input in a left-side partition 271 of the display panel 223 by default.

Again, in some embodiments if there is a wireless connection between the information handling system 200 and the third antenna 265 (e.g., the left side) has a stronger RSSI than a wireless connection with the fourth antenna 266 (e.g., the right side), for example, it may be determined that the information handling system 200 is located closer to the third antenna 265 than to the fourth antenna 266. Because the wireless video device position and display coordination system associates the third antenna 265 with the left side of the display panel 223 in an embodiment, the wireless video device position and display coordination system is executed to determine that the information handling system 200 is located closer to the left side of the display panel 223 than to the right side of the display panel 223 as confirmation that it may be appropriate in this circumstance to display the mobile smart device wireless video data input from the mobile smart device 297 in the right-side partition 272 of the display panel 223 and display the information handling system video data input on the left-side partition 271 of the display panel 223 in one alternative embodiment.

In some embodiments in which the mobile smart device is located equidistant, or not above a signal strength difference threshold, to both of the first antenna 263 and the second antenna 264 of the digital display device 200, the display device hardware controller of the digital display device 200 may execute machine readable code instructions of the PBP video data inputs composer to orchestrate display of the smart device video data input within a previous partition of the display panel 223, which may be either partition 271 or partition 272, for example, as a default or may select a default partition side 272 or 272.

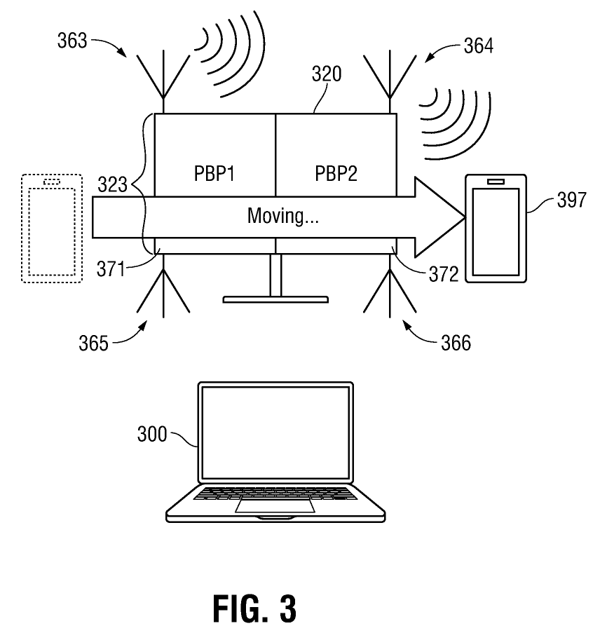

FIG. 3 is a graphical diagram illustrating a digital display device determining an updated position of a mobile smart device with respect to the digital display device based on an updated comparison of signal strengths for wireless links between the mobile smart device and a plurality of antennas of the digital display device according to an embodiment of the present disclosure. As described herein, when the user moves the mobile smart device 397 to a new location, such as on the other side of the digital display device 320 than where it was previously located (as shown in FIG. 2), the digital display device 320 may automatically detect the updated position from periodic assessment of signal strength levels of wireless connections to the first antenna 363 and second antenna 364.

At routine intervals, the wireless video controller of the digital display device 320 in an embodiment may execute machine readable code instructions of the wireless video device position and display coordination system to determine an updated position of the mobile smart device 397 with respect to the display panel 323, such as to the right of the display panel 323, as shown in FIG. 3. This determination may be based on an updated comparison of updated signal strength for the wireless connections between the mobile smart device 397 and the first antenna 363 and between the mobile smart device 397 and the second antenna 364. If a wireless connection with the second antenna 364 has a stronger relative signal strength indicator (RSSI) than the wireless connection with the first antenna 363 by more than a signal strength threshold difference value for a position threshold time period, for example, it may be determined that the mobile smart device 397 is located closer to the second antenna 364 than to the first antenna 363. In some embodiments, a different, higher updated signal strength threshold difference value may be used after an initial position of the mobile smart device 397 was previously established relative to a digital display device 320 to reduce sensitivity to movement versus need to quickly select a partition side during an initial position determination. In other embodiments, a different longer updated position threshold time period may be used after an initial position of the mobile smart device 397 was previously established relative to a digital display device 320 to reduce sensitivity to movement versus need to quickly select a partition side during an initial. In other embodiments, both a different higher updated signal strength threshold difference value and a longer update position threshold time period may be used after an initial position of the mobile smart device 397 was previously established relative to a digital display device 320 to reduce sensitivity to movement.

Because the wireless video device position and display coordination system associates the second antenna 364 with the right side of the display panel 323 in an embodiment, the wireless video controller or display device hardware controller of the digital display device 320 in such an embodiment may execute machine readable code instructions of the wireless video device position and display coordination system to determine that the mobile smart device 397 has changed to be located closer to the right side of the display panel 323 than to the left side of the display panel 323. As described in greater detail herein, it may be appropriate in this circumstance to switch to display the mobile smart device video data input from the mobile smart device 397 in a right-side partition 372 of the display panel 323 located closest to the mobile smart device 397 after the user has moved the mobile smart device 397 from the left side of the digital display device 320 to the right side of the digital display device 320.

It may be determined in an embodiment whether the position of the mobile smart device 397 with respect to the display panel 323 of the digital display device 320 has changed sufficiently to warrant redistribution of the smart device video data input into a different partition of the display panel 323. For example, if the wireless video controller in an embodiment determines that the mobile smart device 397 has moved from an initial position located closest to a first antenna 363 located closest to the left vertical edge of the display panel 323 to an updated position located closest to a second antenna 364 located closest to the right vertical edge of the display panel 323, this may warrant shifting of the smart device video data input to a different partition (e.g., from 371 to 372) of the display panel 323.

FIG. 4 is a graphical diagram illustrating a digital display device automatically updating the display of video data input received from a mobile smart device within a partition of the digital display device display panel located closest to an updated position of the mobile smart device after the mobile smart device moves with respect to the digital display device according to an embodiment of the present disclosure. As described herein, when the user moves the mobile smart device 497 to a new location, such as on the other side of the digital display device 420 than where it was previously located (as shown in FIG. 2 above), the digital display device 420 in an embodiment may automatically detect the updated position and adjust the display of video data input received from that mobile smart device 497 to appear within a portion of the digital display device 420 located nearest this updated position. As described above with respect to FIG. 3, the wireless video controller of the digital display device 420 may determine that the mobile smart device 497 has moved from an initial position located closest to a first antenna 463 to an updated position located closest to a second antenna 464. In such an embodiment, In embodiments herein, the display device hardware controller of the digital display device 420 may execute machine readable code instructions of the PBP video inputs composer switch and to render the mobile smart device wireless video input data received on a primary wireless link on the right partition 472 of the display panel 423. Further, in embodiments herein, the display device hardware controller of the digital display device 420 may execute machine readable code instructions of the PBP video inputs composer switch and to render the information handling system video input data, whether received on wired port or a secondary wireless link, on the left partition 471 of the display panel 423 by default in embodiments herein.

It is contemplated that the reverse switch in position of the mobile smart device 497 may occur as well. In such an example embodiment, in which the wireless video controller determines that the mobile smart device 497 has moved from an initial position closest to a second antenna 464 located closest to the right vertical edge of the display panel 423 to an updated position closest to the first antenna 463 located closest to the left vertical edge of the display panel 423, the display device hardware controller may execute machine readable code instructions of the PBP video data inputs composer to orchestrate shifting of the display of the smart device wireless video data input received from the mobile smart device 497 from the partition 472 on the right side of the display panel 423 to the partition 472 on the left side of the display panel 423. Similarly, the display device hardware controller may execute machine readable code instructions of the PBP video data inputs composer to orchestrate shifting of the display of the information handling system video data input received from the information handling system 400 from the partition 471 on the left side of the display panel 423 to the partition 472 on the right side of the display panel 423. This may provide a more intuitive user experience, based on actual placement of the mobile smart device 497 as it moves with respect to the digital display device 420.

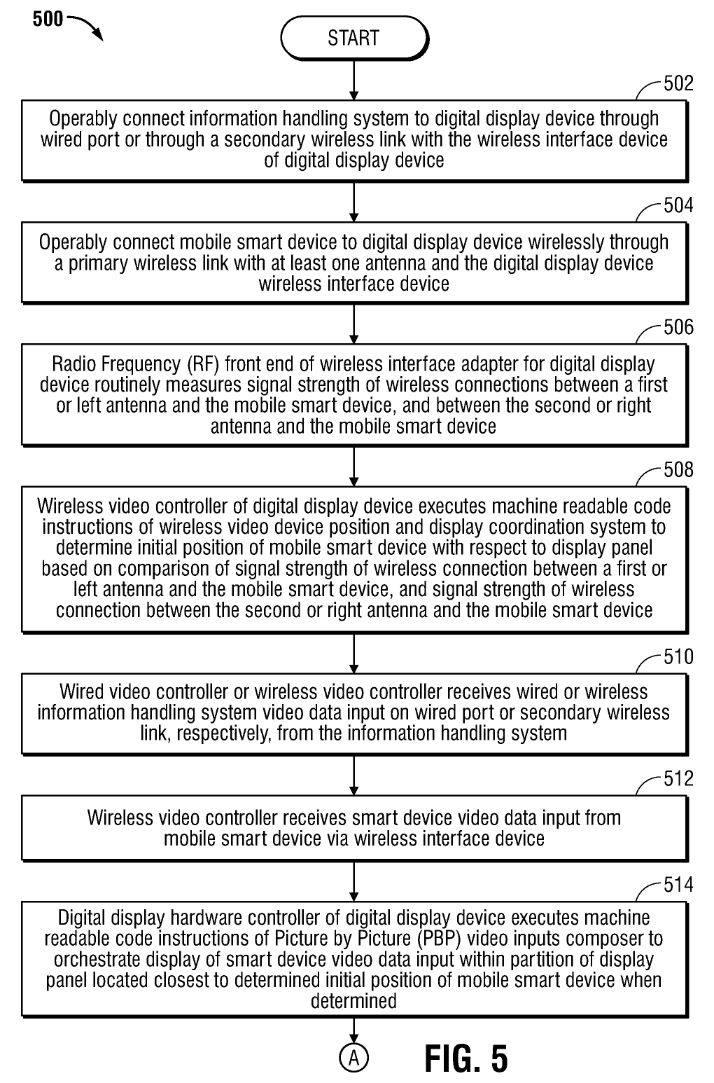

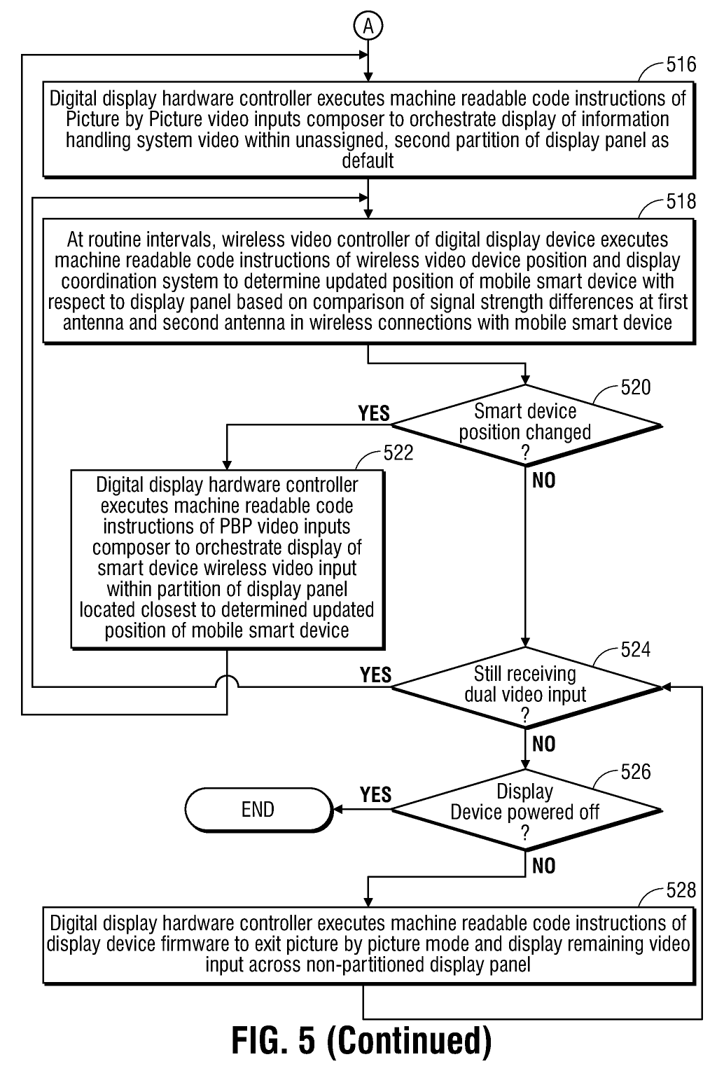

FIG. 5 is a flow diagram illustrating a method of orchestrating display of video data input received from a mobile smart device within partitions of a display panel for a digital display device located closest to a determined initial or updated position of the mobile smart device, as determined based on comparison of signal strengths for wireless connections with a plurality of antennas located on opposing sides of the digital display device according to an embodiment of the present disclosure. As described herein, a digital display device executing machine readable code instructions of a wireless video device position and display coordination system and a picture by picture (PBP) video data inputs composer in an embodiment may automatically detect a position of a mobile smart device with respect to the digital display device. The digital display device executing machine readable code instructions of a wireless video device position and display coordination system and a picture by picture (PBP) video data inputs composer in an embodiment may automatically display mobile smart device video data input received on a partition side of the digital display device located nearest to the identified position of the mobile smart device. Additional information handling system video data input received on a secondary wired or wireless connection may be rendered by default on the opposite partition side of the digital display device in embodiments herein. This may provide a more intuitive user experience in that the user may expect to see the video data input from the mobile smart device near to its relative physical location. Further, when the user moves the mobile smart device to a new location, such as on the other side of the digital display device than where it was previously located, the digital display device in an embodiment may automatically detect the updated position and adjust the display of video data input received from that mobile smart device to appear within a partition of the digital display device located nearest this updated position of the mobile smart device.

At block 502, an information handling system in an embodiment may be operably connected to a digital display device through a wired video port or through a secondary wireless link with a wireless interface device of a digital display device. The digital display device wireless interface adapter may determine the type of information handling system on the secondary wireless link is not a mobile smart device such as a smart phone or tablet, but instead a computer system such as a laptop information handling system, desktop information handling system or the like from identification data received from the information handling system identifying the information handling system type. This identification of type of information handling system may be provided to a display device controller at the digital display device in embodiments herein.

In an embodiment described with respect to FIG. 2, an information handling system 200 may be operably connected to a digital display device 220 through a wired video port or through a wireless link with a wireless interface device of a digital display device 220 that is designated as a secondary wireless link at the display device hardware controller based on identification data for the information handling system 200 identifying it as a laptop or desktop information handling system, for example. When operatively coupled, the digital display device 220 may receive a video data signal from such an operatively coupled information handling system either wirelessly, via an established wireless link at the display device wireless interface adapter, or through a wired communication port such as a universal serial bus type-C (USB-C) port, USB 3.0 port, high definition multimedia interface (HDMI) port, DisplayPort ® (DP), or mini-DP ®, for example.

A mobile smart device in an embodiment at block 504 may be operably connected to the digital display device wirelessly through a wireless link with an antenna and the display device wireless interface adapter. Further, the mobile smart device may be wirelessly connected with a first antenna and a second antenna, each disposed on opposite sides of the digital display device, to determine which antenna to establish a wireless link under a given wireless protocol for wireless data communications. This wireless link with a display device wireless interface adapter may be designated as a primary wireless link based on device identification data received from the mobile smart device identifying it as a smartphone or tablet information handling system in embodiments herein.

In an embodiment described with respect to FIG. 1, a mobile smart device 197 may be operably connected to the digital display device 120 wirelessly through wireless connections, one of which may be designated as a primary wireless link, with both a first antenna 163 and a second antenna 164 of a wireless interface device 160 disposed on opposite sides of the digital display device 120. The first antenna 163 and second antenna 164 may be situated on a display device housing on either side (e.g., right side and left side) of the display panel 123 or close to different vertical edges of the display panel 123 in an embodiment. The mobile smart device 197 may provide device identification identifying it as a smart mobile device 197, such as a smartphone or tablet information handling system, for example. This device identification data from the smart mobile device 197 may be forwarded to the display device hardware controller 121 for use in embodiments herein for determining which of the information handling system 100 or mobile smart device 197 may accommodate a primary wireless link when both are wirelessly coupled for decision as to which video data feed is to be moved according to detected position. It is contemplated that in some embodiments that either the information handling system 100 or mobile smart device 197 may accommodate a primary wireless link and be designated for adjustment of a side of displayed video data input. For example, laptop device video data input may be moved with respect to location of the laptop device 100 relative to the digital display device 120 in some embodiments. However, in embodiments discussed herein, movement of an identified mobile smart device 197 may adjust display of mobile smart device wireless video data input on a display panel 123 with respect to location of the mobile smart device 197 relative to the digital display device 120. In some embodiments herein, the wireless link with the mobile smart device 197 is designated as a primary wireless link if both the mobile smart device 197 and information handling system 100 have wireless links to the digital display device 120. In other embodiments, the information handling system 100 is operatively coupled to provide information handling system video data input via a wired connection at a wired port which is thus designated as a secondary video data input feed.

At block 506, a Radio Frequency (RF) front end of the wireless interface adapter for the digital display device in an embodiment may routinely measure signal strengths of the wireless connections between the mobile smart device and the first antenna and between the mobile smart device and the second antenna on opposite sides of the housing of the digital display device. For example, an RF front end of the wireless interface adapter for the digital display device in an embodiment may routinely measure signal strengths from the mobile smart device of the wireless connections at a first antenna and a second antenna, such as left antenna 263 and right antenna 264 of FIG. 2 for example. In one alternative embodiment in which the information handling system is operably connected via wireless connections to a third antenna and a fourth antenna, such as 265 and 266 of the digital display device 220 in FIG. 2, the RF front end of the wireless interface adapter for the digital display device may also routinely measure signal strengths for confirmation of location of the information handling system 200 and, therefore, an additional inference of the location for the mobile smart device 297. As described in greater detail in an embodiment with respect to FIG. 1, the RF front end 162 may routinely check a relative signal strength indicator (RSSI) for each wireless link established with antennas 163 and 164. The wireless connection between the mobile smart device 197 and the antenna (e.g., 163) situated nearest the mobile smart device 197 should have a higher RSSI in comparison to the RSSI of the wireless connection between the mobile smart device 197 and the antenna 164 situated farther from the mobile smart device 197.

A wireless video controller or the digital display hardware controller of the digital display device in an embodiment at block 508 may execute machine readable code instructions of a wireless video device position and display coordination system to receive signal strength data for the first antenna and for the second antenna and determine an initial position of the mobile smart device with respect to a display panel of the digital display device based on known location sides of the first antenna and the second antenna. This determination may be based on a comparison of a radiofrequency signal strength, in dBm, for the mobile smart device and a first antenna on a first side and a radiofrequency signal strength for the mobile smart device and a second antenna on a second side of the digital display device. The wireless video controller or the digital display hardware controller may execute machine readable code instructions of a wireless video device position and display coordination system to determine if the signal strength data for the first antenna is greater than the signal strength data for the second antenna or vice-versa by a signal strength threshold difference value to determine an initial location of the mobile smart device relative to the digital display device in an embodiment. In a further embodiment, the wireless video controller or the digital display hardware controller may execute machine readable code instructions of a wireless video device position and display coordination system to determine if the signal strength data for the first antenna is greater than the signal strength data for the second antenna or vice-versa by a signal strength threshold difference value for a position threshold time period to determine the initial location of the mobile smart device relative to the digital display device.

For example, in an embodiment described with respect to FIG. 2, a wireless video controller of the digital display device 200 may execute machine readable code instructions of a wireless video device position and display coordination system to determine an initial position of the mobile smart device 297 to a first side (e.g., the left side) of the display panel 223 of the digital display device 220 due to a stronger signal strength of the wireless connection with first antenna 263 shown on the left side. If a wireless connection with a first antenna 263 has a stronger RSSI than a wireless link with the second antenna 264, for example, it may be determined that the mobile smart device 297 is located closer to the first antenna 263 than to the second antenna 264. Because the wireless video device position and display coordination system associates the first antenna 263 with the left side of the display panel 223 in an embodiment due to known fixed position of those antennas, the wireless video controller of the digital display device 200 in such an embodiment may execute machine readable code instructions of the wireless video device position and display coordination system to determine that the mobile smart device 297 is located closer to the left side of the display panel 223 than to the right side of the display panel 223. As described in greater detail herein, it may be appropriate in this circumstance to display the mobile smart device wireless video data input for the mobile smart device 297 in a left-side partition 271 of the display panel 223 located closest to the mobile smart device 297.

In one alternate embodiment in cases where the information handling system 200 is operably connected via wireless connections with a third antenna 265 and a fourth antenna 266 also on opposing sides of the digital display device 220, this determination of location may be further confirmed by a comparison of signal strength of wireless connection between the information handling system 200 and the third antenna 265 and the signal strength of the wireless connection between the information handling system 200 and the fourth antenna 266. If a wireless connection between the information handling system 200 and the antenna 266 has a stronger RSSI than a wireless connection with the antenna 265, for example, it may be determined that the information handling system 200 is located closer to the antenna 266 than to the antenna 265 and it may be inferred as confirmation that the mobile smart device 297 is not closer to antenna 266, such as in a space such as a desktop surface before digital display device 220.

In another example embodiment, the wireless connection with second antenna 264 has a stronger RSSI than the wireless connection with the first antenna 263, it may be determined that the mobile smart device 297 is located closer to the second antenna 264 than to the first antenna 263 in an initial position. Because the wireless video device position and display coordination system associates the second antenna 264 with the right side of the display panel 223 in an embodiment, the wireless video controller of the digital display device 200 in such an embodiment may execute machine readable code instructions of the wireless video device position and display coordination system to determine that the mobile smart device 297 is located closer to the right side of the display panel 223 than to the left side of the display panel 223. As described in greater detail herein, it may be appropriate in this circumstance to display the mobile smart device video data input from the mobile smart device 297 in the right-side partition 272 of the display panel 223 on the side of the second antenna 264 located closest to the mobile smart device 297. In an alternate embodiment, this right-side position of the mobile smart device may be confirmed by determining location based on signal strength between the information handling system 200 and the third antenna 265 has a stronger RSSI than a wireless connection with the fourth antenna 266 to determine that the information handling system 200 is located closer to the left side third antenna 265 than to the right side fourth antenna 266. By inference, the mobile smart device 297 may not be located on that left side as confirmation of the above in some embodiments.

At block 510, a wired video controller or wireless video controller of the digital display device in an embodiment may receive information handling system video data input via a wired port or a secondary wireless link, respectively, from the information handling system. For example, a wired video controller 150 or wireless video controller 151 of the digital display device 100 in an embodiment may receive information handling system video data input, respectively via wired port 166 or via a secondary wireless link at the display device wireless interface adapter 160, from the information handling system 100. The digital display device 120 may receive this information handling system video input data as a video signal from an operatively coupled information handling system either wirelessly, via wireless interface adapter 160 on a secondary wireless link as determined from device identification of the information handling system 100, or through a wired communication port 166 such as a universal serial bus type-C (USB-C) port, USB 3.0 port, high definition multimedia interface (HDMI) port, DisplayPort ® (DP), or mini-DP ®, for example. The wired video controller 150 or the wireless video controller 151 operates a codec to receive the information handling system video input data at the particular wireless protocol format or port format and transfer that information handling system video input data to the display device hardware controller 121. The display device hardware controller 121 includes DSP and scaler processing such that it may then render images on the display panel 123 for the information handling system video input data.

The wireless video controller in an embodiment at block 512 may receive a smart device video data input from the mobile smart device, via the primary wireless link established with digital display device wireless interface device via one of the first antenna or the second antenna. For example, the wireless video controller 151 in an embodiment may receive a smart device video data input from the mobile smart device 197, via the wireless interface device of the digital display device 120. The wireless link with the mobile smart device 197 and either a first antenna 163 or a second antenna 164 may be designated as a primary wireless link based in device identification data received from the smart mobile device 197 designating it as the device to move the rendered information handling system video input data for when location is detected in embodiments herein. The wireless video controller 151 operates a codec to receive the mobile smart device wireless video input data at the particular wireless protocol format and transfer that mobile smart device video input data to the display device hardware controller 121. This also triggers, at the display device controller 121, execution of machine readable code instructions of a picture by picture (PBP) video data inputs composer to accommodate display of images for both the information handling system video input data and the mobile smart device video input data such as in a partitioned image on the display panel 123. The display device hardware controller 121 includes DSP and scaler processing such that it may then render images on the display panel 123 for the mobile smart device video input data and information handling system video input data in embodiments herein.

At block 514, a display device hardware controller of the digital display device in an embodiment may execute machine readable code instructions of the picture by picture (PBP) video data inputs composer to orchestrate display of the smart device video data input received from the mobile smart device within a partition of the display panel located closest to the determined initial position of the mobile smart device relative to the digital display device. As described above, the partition side selected for the mobile smart device video data input is determined from execution of the machine readable code instructions of a wireless video device position and display coordination system to determine if the signal strength data for the first antenna is greater than the signal strength data for the second antenna or vice-versa by a signal strength threshold difference value to determine the location of the mobile smart device relative to the digital display device in an embodiment. In a further embodiment, the wireless video controller or the digital display hardware controller may execute machine readable code instructions of a wireless video device position and display coordination system to determine if the signal strength data for the first antenna is greater than the signal strength data for the second antenna or vice-versa by a signal strength threshold difference value for a position threshold time period to determine the initial location of the mobile smart device relative to the digital display device and determine the partition side for display of the mobile smart device video data input.

In another example embodiment in which the mobile smart device is located equidistant to both of the first antenna and the second antenna of the digital display device in that the signal strength of neither the first antenna or the second antenna is above a signal strength threshold value (in dBm), the display device hardware controller of the digital display device may execute machine readable code instructions of the PBP video data inputs composer to orchestrate display of the smart device video data input within a previously-selected partition side or a default initial partition side of the display panel.

At block 516, the display device hardware controller of the digital display device in an embodiment may execute machine readable code instructions of the PBP video data inputs composer to orchestrate display of the information handling system video data input received from the information handling system within an unassigned, second partition of the display panel. For example, in an embodiment in which the smart device video data input received from the mobile smart device is set to display within a first partition side, such as 271 of FIG. 2 of the display panel 223, the display device hardware controller of the digital display device may execute machine readable code instructions of the PBP video data inputs composer to orchestrate display of the information handling system video data input received from the information handling system 200 within an unassigned, second partition side, such as 272 of the display panel 223 as a default. As described, the wired reception or wirelessly received information handling system video data input is received on a designated secondary wireless link or secondary wired connection and thus this information handling system video data input is rendered by the display device hardware controller on the second partition side of the display panel by default that is not designated for the mobile smart device video data input in embodiments herein.

In another example embodiment, in which the smart device video data input received from the mobile smart device 297 is set to display within the partition 272 of the display panel 223, the display device hardware controller of the digital display device 200 may execute machine readable code instructions of the PBP video data inputs composer to orchestrate display of the information handling system video data input received from the information handling system 200 within an unassigned, second partition 271 of the display panel 223 not designated for the mobile smart device 297 as default.

At block 518, at routine intervals, the wireless video controller or display device hardware controller of the digital display device in an embodiment may execute machine readable code instructions of the wireless video device position and display coordination system to determine an updated position of the mobile smart device with respect to the display panel based on an updated comparison of updated signal strength for wireless connections with a first antenna and a second antenna. For example, at routine intervals, the wireless video controller or digital display device hardware controller in an embodiment described with respect to FIG. 3 may execute machine readable code instructions of the wireless video device position and display coordination system to determine an updated position of the mobile smart device 397 with respect to the display panel 323, such when the mobile smart device 397 has been moved from the left to the right of the display panel 323. This determination may be based on an updated comparison of updated signal strength for wireless connection between the mobile smart device 397 and the first antenna 363 and the updated signal strength for wireless connection between the mobile smart device 397 and the second antenna 364 reaching an updated signal strength threshold difference value. If a wireless connection with the second antenna 364 has a stronger relative signal strength indicator (RSSI) than the wireless link with the first antenna 363 by an amount exceeding the updated signal strength threshold difference value, for example, it may be determined that the mobile smart device 397 is moved and now located closer to the second antenna 364 than to the first antenna 363. Because the wireless video device position and display coordination system associates the second antenna 364 with the right side of the display panel 323 in an embodiment, the wireless video controller of the digital display device 320 in such an embodiment may execute machine readable code instructions of the wireless video device position and display coordination system to determine that the mobile smart device 397 is moved located closer to the right side of the display panel 323 than to the left side of the display panel 323. As described in greater detail herein, it may be appropriate in this circumstance to display the mobile smart device video data input from the mobile smart device 397 in a right-side partition 372 of the display panel 323 located closest to the mobile smart device 397 after the user has moved the mobile smart device 397 from the left side of the digital display device 320 to the right side of the digital display device 320.

In may be determined in an embodiment at block 520 whether the position of the mobile smart device with respect to the display panel of the digital display device has changed sufficiently, such that the updated signal strength threshold difference value is met, to warrant redistribution of the smart device video data input being rendered into a different partition of the display panel. For example, if the wireless video controller in an embodiment determines at block 518 that the mobile smart device has moved from an initial position located closest to a first antenna located closest to the left vertical edge of the display panel to an updated position located closest to a second antenna located closest to the right vertical edge of the display panel, this may warrant shifting of the smart device video data input rendering to a different, right-side partition of the display panel.

If the position of the mobile smart device has changed as determined by comparison of signal strengths at the first antenna and the second antenna exceeding the updated signal strength threshold difference value, then method may proceed to block 522 for such redistribution via the digital display hardware processor executing the machine readable code instructions of the PBP video data inputs composer. In another example embodiment, it may be determined that the position of the mobile smart device has not changed sides, or that the position of the mobile smart device has changed, but the comparative signal strengths at the first antenna and the second antenna have not met the updated signal strength threshold difference value. In this embodiment, the mobile smart device may still be located closest to the same first antenna to which it was located most closely previously or it may be located in the middle. If the wireless video controller or the display device hardware controller determines the position of the mobile smart device with respect to the display panel of the digital display device has not changed sufficiently to warrant redistribution of the smart device video data input into a different partition of the display panel, the method may proceed to block 524 for determination as to whether the digital display device is still receiving both the smart device video data input and the information handling system video data input.

At block 522, in an embodiment in which the wireless video controller determines that the mobile smart device has moved from an initial position located closest to a first antenna to an updated position located closest to a second antenna, the display device hardware controller may execute machine readable code instructions of the PBP video data inputs composer to orchestrate display of the smart device wireless video data input within a partition of the display panel located closest to the determined updated position of the mobile smart device. For example, in an example embodiment in which the wireless video controller determines that the mobile smart device has moved from an initial position closest to a first antenna located closest to the left vertical edge of the display panel to an updated position closest to a second antenna located closest to the right vertical edge of the display panel, the display device hardware controller may execute machine readable code instructions of the PBP video data inputs composer to orchestrate shifting of the display of the smart device wireless video data input from a partition on the left side of the display panel to a partition on the right side of the display panel. In another example embodiment, in which the wireless video controller determines that the mobile smart device has moved from an initial position closest to a second antenna located closest to the right vertical edge of the display panel to an updated position closest to a first antenna located closest to the left vertical edge of the display panel, the display device hardware controller may execute machine readable code instructions of the PBP video data inputs composer to orchestrate shifting of the display of the smart device wireless video data input from a partition on the right side of the display panel to a partition on the left side of the display panel. This may provide a more intuitive user experience, based on actual placement of the mobile smart device as it moves with respect to the digital display device. An example of this may be seen and is described with respect to FIG. 4.

The method may then proceed back to block 516 for redistribution of the information handling system video data input to the currently unassigned partition. For example, if the display device hardware controller executes machine readable code instructions of the PBP video data inputs composer to shift display of the smart device wireless video data input from a left-sided partition to a right-sided partition of the display panel, the display device hardware controller may also execute machine readable code instructions of the PBP video data inputs composer to shift display of the information handling system video data input from the right-sided partition to the left-sided partition by default. As another example, if the display device hardware controller executes machine readable code instructions of the PBP video data inputs composer to shift display of the smart device wireless video data input from a right-sided partition to a left-sided partition of the display panel, the display device hardware controller may also execute machine readable code instructions of the PBP video inputs composer to shift display of the information handling system video data input from the left-sided partition to the right-sided partition by default. By repeating the loop between blocks 516 and 522 in such a way, the video controller and display device hardware controller of the digital display device executing machine readable code instructions of wireless video device position and display coordination system and of the PBP video data inputs composer to continuously ensure display of the smart device video data input on the side of the display panel currently located closest to the mobile smart device. In such a way, the digital display device executing machine readable code instructions of a wireless video device position and display coordination system and a picture by picture (PBP) video data inputs composer may automatically display video data input received from a mobile smart device on a portion of the digital display device located nearest an identified initial or updated position for the mobile smart device with respect to the digital display device. This may provide a more intuitive user experience in that the user may expect to see the video data input from the mobile smart device near to its physical location.

Returning to block 524, in an embodiment in which it is determined that the position of the mobile smart device has not changed, or that the position of the mobile smart device has changed, but it is still located closest to the same primary antenna to which it was located most close to previously or is in the middle, the video controller may determine whether it is still receiving smart device video data input from the mobile smart device as well as information handling system video data input for simultaneous display, requiring display of that smart device video data input in a selected partition side of the display panel for the location of the mobile smart device. For example, in an embodiment in which it is determined that the position of the mobile smart device has not changed, or that the position of the mobile smart device has changed, but it is still located closest to the same primary antenna to which it was located most closely previously or in the middle, no redistribution of video data inputs to various partitions of the display panel may be needed. The display device hardware controller may continue to await a need for such redistribution, so long as a smart device video data input is being received along with the information handling system video data input for simultaneous display. Thus, if the video controller is still receiving the smart device video data input and the information handling system video data input at block 524, the method may proceed back to block 518 for determining an updated position of the mobile smart device with respect to the display panel that may warrant redistribution of the smart device video data input into a different partition of the display panel, as described herein. If the video controller is not receiving the smart device video data input and the information handling system video data input at block 534, the method may proceed to block 526 for determination as to whether the digital display device has been powered off.

In an embodiment in which the video controller has ceased receiving the smart device video data input, it may be determined whether the display device has been powered down at block 526. If the display device has not been powered off, the video controller may still be receiving the information handling system video data input, but there may no longer be a need to partition the display panel to display the smart device video data input in addition to the information handling system video data input. In such a case, the method may proceed to block 528 to exit picture by picture mode. If the digital display device has been powered off, the method for orchestrating display of video data input received from a mobile smart device within a partition of a digital display device display panel located closest to a determined initial or updated position of the mobile smart device may then end.

At block 528, in an embodiment in which a video controller is receiving the information handling system video data input, but the same or another video controller has stopped receiving the smart device video data input, the display device hardware controller of the digital display device may execute machine readable code instructions of the display device firmware to exit picture by picture mode and display the remaining information handling system video data input across a non-partitioned display panel. The method may return to block 524 for determination if both the mobile smart device video data input and the information handling system video data input are both being received again and to reinstate picture by picture mode and proceed as described above.

The blocks of the flow diagram of FIG. 5 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

1. A digital display device executing machine readable code instructions of a wireless video device position and display coordination system comprising:
a first antenna situated on a display housing exterior to a first vertical boundary of a display panel and a second antenna on the display housing situated exterior to a second vertical boundary of the display panel of the digital display device for establishing a wireless connections with a mobile smart device;
a display device wireless interface adapter to route a received mobile smart device video data input from the mobile smart device to a display device hardware controller for rendering images on a display panel from the mobile smart device video data input and to routinely measure signal strengths of each of the wireless connections between the mobile smart device and the first antenna and between the mobile smart device and the second antenna;
the display device hardware controller to receive information handling system video data input from an information handling system operably connected to the digital display device for rendering images on the display panel from the information handling system video data input;
the display device hardware controller to execute machine readable code instructions of a wireless video device position and display coordination to determine a position of the mobile smart device that is closer to the first antenna than to the second antenna based on a determination that the signal strength of the wireless connection between the mobile smart device and the first antenna is stronger than the signal strength of the wireless connection between the mobile smart device and the second antenna; and
the display device hardware controller to execute machine readable code instructions to orchestrate display of the mobile smart device video data input within a first partition of the display panel located closest to the determined position of the mobile smart device based on the signal strength of the wireless connection between the mobile smart device and the first antenna.

2. The digital display device of claim 1, wherein the first signal strength for wireless connection between the mobile smart device and the first antenna is greater than the second signal strength for wireless connection between the mobile smart device and the second antenna by more than a signal strength threshold difference value.

3. The digital display device of claim 2, wherein the signal strength threshold difference value is at least three decibels relative to one milliwatt (dBm).

4. The digital display device of claim 1, wherein the first signal strength for wireless connection between the mobile smart device and the first antenna is greater than the second signal strength for wireless connection between the mobile smart device and the second antenna by more than a signal strength threshold difference value that lasts for more than a position threshold time period.

5. The digital display device of claim 1 further comprising:
the display device hardware controller to execute machine readable code instructions to orchestrate display of the information handling system video data input within a second partition of the display panel.

6. The digital display device of claim 1 further comprising:
the display device hardware controller receives information handling system video data input from an information handling system via a wired port that is designated as secondary to a wireless link established to receive the mobile smart device video data input from a wireless link designated as primary such that the display device hardware controller executes machine readable code instructions to orchestrate the display of the wireless video data input from the wireless link designated as primary within the first partition of the display panel selected for being located closest to the determined initial position of the mobile smart device.

7. The digital display device of claim 1 further comprising:
the display device hardware controller receives information handling system video data input from an information handling system via a wireless link that is designated as secondary to a wireless link established to receive the mobile smart device video data input from a wireless link designated as primary such that the display device hardware controller executes machine readable code instructions to orchestrate the display of the wireless video data input from the wireless link designated as primary within the first partition of the display panel selected for being located closest to the determined initial position of the mobile smart device.

8. The digital display device of claim 1 further comprising:
a first video controller to execute machine readable code instructions to determine an updated determination that the signal strength of the wireless connection between the mobile smart device and the second antenna is stronger than the signal strength of the wireless connection between the mobile smart device and the first antenna by more than an updated signal strength threshold difference value; and
the display device hardware controller to execute machine readable code instructions to automatically orchestrate display of the mobile device video data input within a second partition of the display panel located closest to the determined updated position of the mobile smart device based on the signal strength of the wireless connection between the mobile smart device and the second antenna.

9. A method of wireless video device position and display coordination comprising:
establishing a wireless connections with a mobile smart device via a display device wireless interface adapter and a first antenna situated on a display housing exterior to a first vertical boundary of a display panel and a second antenna on the display housing situated exterior to a second vertical boundary of the display panel of the digital display device;
receiving information handling system video data input from an information handling system operably connected to the digital display device at the display device hardware controller for rendering images on the display panel from the information handling system video data input;
establishing a first wireless connection with the mobile smart device as a wireless link via the display device wireless interface adapter to receive mobile smart device video data input from the mobile smart device and route the mobile smart device video data input to a display device hardware controller triggering execution of machine readable code instructions of a picture by picture (PBP) video inputs composer for a PBP mode for rendering images from the information handling system video data input as well as the mobile smart device video data input on the display panel partitioned into a first partition and a second partition;
routinely measuring signal strengths of each of the wireless connections between the mobile smart device and the first antenna and between the mobile smart device and the second antenna with the display device wireless interface adapter;
executing machine readable code instructions of a wireless video device position and display coordination, via the display device hardware controller to determine a position of the mobile smart device that is closer to the first antenna than to the second antenna based on a determination that the signal strength of the wireless connection between the mobile smart device and the first antenna is stronger than the signal strength of the wireless connection between the mobile smart device and the second antenna; and
execute, via the display device hardware controller, the machine readable code instructions of the PBP video inputs composer to orchestrate display of the mobile smart device video data input within a first partition of the display panel located closest to the determined position of the mobile smart device based on the signal strength of the wireless connection between the mobile smart device and the first antenna.

10. The method of claim 9 further comprising:
executing, via the display device hardware controller, the machine readable code instructions of the PBP video inputs composer to orchestrate display of the information handling system video data input within the second partition of the display panel.

11. The method of claim 9, wherein the first signal strength for wireless connection between the mobile smart device and the first antenna is greater than the second signal strength for wireless connection between the mobile smart device and the second antenna by more than a signal strength threshold difference value.

12. The method of claim 9, wherein the first signal strength for wireless connection between the mobile smart device and the first antenna is greater than the second signal strength for wireless connection between the mobile smart device and the second antenna by more than a signal strength threshold difference value that lasts for more than a position threshold time period.

13. The method of claim 9 further comprising:
to determining, via afirst video controller executing machine readable code instructions, an updated determination that the signal strength of the wireless connection between the mobile smart device and the second antenna is stronger than the signal strength of the wireless connection between the mobile smart device and the first antenna by more than the a signal strength threshold difference value; and
to executing machine readable code instructions, via the display device hardware controller, to automatically orchestrate display of the mobile device video data input within the second partition of the display panel located closest to the determined updated position of the mobile smart device based on the signal strength of the wireless connection between the mobile smart device and the second antenna.

14. A digital display device executing machine readable code instructions of a wireless video device position and display coordination system comprising:
a first antenna situated on a display housing exterior to a first vertical boundary of a display panel and a second antenna on the display housing situated exterior to a second vertical boundary of the display panel of the digital display device for establishing a wireless connections with a mobile smart device;
a display device hardware controller to receive information handling system video data input from an information handling system operably connected to the digital display device for rendering images from the information handling system video data input on the display panel;
the display device wireless interface adapter to route a received mobile smart device video data input from the mobile smart device to a display device hardware controller triggering execution of machine readable code instructions of a picture by picture (PBP) video inputs composer for a PBP mode for rendering images from the information handling system video data input as well as the mobile smart device video data input on the display panel partitioned into a first partition and a second partition;
the display device hardware controller to execute machine readable code instructions of a wireless video device position and display coordination to determine a position of the mobile smart device that is closer to the first antenna than to the second antenna based on a determination that the signal strength of the wireless connection between the mobile smart device and the first antenna is stronger than the signal strength of the wireless connection between the mobile smart device and the second antenna by more than a signal strength threshold difference value; and
the display device hardware controller to execute machine readable code instructions to orchestrate display of the mobile smart device video data input within the first partition of the display panel located closest to the determined position of the mobile smart device based on the signal strength of the wireless connection between the mobile smart device and the first antenna.

15. The digital display device of claim 14, wherein the signal strength threshold difference value is at least three decibels relative to one milliwatt (dBm).

16. The digital display device of claim 14, wherein the first signal strength for wireless connection between the mobile smart device and the first antenna greater than the second signal strength for wireless connection between the mobile smart device and the second antenna by more than the signal strength threshold difference value and for more than a position threshold time period.

17. The digital display device of claim 14 further comprising:
the display device hardware controller to execute machine readable code instructions to orchestrate display of the information handling system video data input within the second partition of the display panel.

18. The digital display device of claim 14 further comprising:
the first video controller to execute machine readable code instructions to determine an updated determination that the signal strength of the wireless connection between the mobile smart device and the second antenna is stronger than the signal strength of the wireless connection between the mobile smart device and the first antenna by more than the signal strength threshold difference value; and
the display device hardware controller to execute machine readable code instructions to automatically orchestrate display of the mobile device video data input within the second partition of the display panel located closest to the determined updated position of the mobile smart device based on the signal strength of the wireless connection between the mobile smart device and the second antenna.

19. The digital display device of claim 14 further comprising:
the first video controller to execute machine readable code instructions to determine an updated determination that the signal strength of the wireless connection between the mobile smart device and the second antenna is stronger than the signal strength of the wireless connection between the mobile smart device and the first antenna by more than an updated signal strength threshold difference value that is different than the signal strength difference value; and
the display device hardware controller to execute machine readable code instructions to automatically orchestrate display of the mobile device video data input within the second partition of the display panel located closest to the determined updated position of the mobile smart device based on the signal strength of the wireless connection between the mobile smart device and the second antenna.

20. The digital display device of claim 14 further comprising:
the first video controller to execute machine readable code instructions to determine an updated determination that the signal strength of the wireless connection between the mobile smart device and the second antenna is stronger than the signal strength of the wireless connection between the mobile smart device and the first antenna by more than an updated signal strength threshold difference value that is different than the signal strength difference value and that lasts for more than a position threshold time period; and
the display device hardware controller to execute machine readable code instructions to automatically orchestrate display of the mobile device video data input within the second partition of the display panel located closest to the determined updated position of the mobile smart device based on the signal strength of the wireless connection between the mobile smart device and the second antenna.
